(19) United States
(12) Patent Application Publication
(10) Pub. No.: US 2009/0262939 A1
(43) Pub. Date: Oct. 22, 2009

(54) Authentication Apparatus, System and Method

(75) Inventor: Feng Jian Chou, Hsinchu Hsien (TW)

Correspondence Address: WPAT, PC, 7225 BEVERLY ST., ANNANDALE, VA, 22003, US

(73) Assignee: MSTAR SEMICONDUCTOR, INC., Hsinchu Hsien (TW)

(21) Appl. No.: 12/419,648

(22) Filed: Apr. 7, 2009

(30) Foreign Application Priority Data
Apr. 16, 2008 (TW) 097113734

(51) Int. Cl. H04K 1/00; H04B 5/00

(52) U.S. Cl. 380/270; 455/41.1

(57) ABSTRACT

An authentication apparatus includes a communication module, a storage module, a processing module and an authentication module. The communication module, based on a wireless communication protocol, establishes a communication link with an electronic apparatus. The storage module stores a plurality of encryption logics and a plurality of authentication logics corresponding to the plurality of encryption logics. The processing module chooses a first encryption logic among the plurality of encryption logics and transmits the first encryption logic to the electronic apparatus. The authentication module receives authentication data based on the first encryption logic from the electronic apparatus, retrieves a first authentication logic corresponding to the first encryption logic from the storage module, and authenticates the electronic apparatus according to the authentication data based on the first authentication logic.

### CROSS REFERENCE TO RELATED PATENT APPLICATION

This patent application is based on a Taiwan, R.O.C. patent application No. 097113734 filed on Apr. 16, 2008.

### FIELD OF THE INVENTION

The present invention relates to an authentication apparatus, system and method, and more particularly to an authentication apparatus, system and method associated with a Near Field Communication (NFC) electronic apparatus.

### BACKGROUND OF THE INVENTION

In the recent years, non-contact sensing authentication mechanisms using radio frequency identification (RFID) gradually prevail in various aspects, such as transportation tickets, door control systems, electronic petty cash and membership management. In a common RFID authentication, an authentication apparatus first reads an authentication code stored in an authentication object, e.g., a door control card and a membership card, or an electronic apparatus, e.g., a mobile phone. The authentication code is compared with database in the authentication apparatus to determine whether authentication is successful according to the determination from comparison.

However, the current RFID authentication method may involve security complications. Those with bad intentions may secretly acquire authentication codes stored in authentication objects or electronic apparatuses in a user's possession using special reading equipments. The authentication codes then allow those with bad intentions to easily pass authentication of authentication apparatuses to cause the user's losses.

Further, in order to pass authentication of all kinds of authentication apparatuses, the user may need a quite number of authentication objects suitable for corresponding authentication codes. For example, the user may find things inconvenient for having to carry many authentication objects from a public transportation card, an office door control card, a gymnasium membership card, an electronic car key to a mobile phone with electronic cash in order to use corresponding services and functions.

Therefore, an objective of the invention is to provide an authentication apparatus, system and method for overcoming the foregoing drawbacks.

### SUMMARY OF THE INVENTION

The invention provides an authentication apparatus, system and method. Based on a wireless communication protocol, an encryption logic is transmitted to an electronic apparatus. Based on a corresponding authentication logic, the electronic apparatus is authenticated according to authentication data based on the encryption logic transmitted from the electronic apparatus. Thus, sophistication of a security mechanism is increased to prevent those with bad intentions from easily acquiring authentication codes through particular means to cause user losses. Further, the authentication apparatus is compatible with different operating platforms, such that different encryption logics and corresponding authentication logics may be designated according to types of electronic apparatuses. To be more precise, the authentication apparatus is capable of authenticating all kinds of electronic apparatuses. Therefore, user convenience is rendered contributable to new authentication objects or electronic devices for operating in coordination with the authentication apparatus need not be additionally provided.

According to one embodiment of the invention, an authentication apparatus comprises a communication module, a storage module, a processing module and an authentication module. The communication module, based on a wireless communication protocol, establishes a communication link with an electronic apparatus. The storage module stores a plurality of encryption logics and a plurality of authentication logics corresponding to the plurality of encryption logics. The processing module, coupled to the communication module and the storage module, chooses a first encryption logic among the plurality of encryption logics and transmits the first encryption logic to the electronic apparatus via the communication link. The authentication module, coupled to the communication module and the storage module, receives authentication data based on the first encryption logic from the electronic apparatus, retrieves a first authentication logic corresponding to the first encryption logic from the storage module, and authenticates the electronic apparatus according to the authentication data based on the first authentication logic.

According to another embodiment of the invention, an authentication method is used for determining whether an electronic apparatus is approved by a predetermined security mechanism at an authentication reading end. The method comprises steps of choosing a target encryption logic among a plurality of encryption logics according to an operating type of the electronic apparatus, transmitting the target encryption logic to the electronic apparatus via the authentication reading end, generating authentication data by executing the target encryption logic using the electronic apparatus, and determining whether the electronic apparatus is approved by the security mechanism according to the authentication data.

According to yet another embodiment of the invention, an authentication system is used for realizing a security mechanism. The authentication system comprises an electronic apparatus and an authentication reading end. The electronic apparatus has an operating type. The authentication reading end, stored with a plurality of encryption logics, chooses a target encryption logic among the plurality of encryption logics according to the operating type, and transmits the target encryption logic to the electronic apparatus. The electronic apparatus executes the target encryption logic to generate authentication data via a communication protocol. The authentication reading end then determines whether the electronic apparatus is approved by a security mechanism according to the authentication data.

Therefore, the authentication apparatus, system and method according to the invention, based on a communication protocol, first transmit an encryption logic to an electronic apparatus, and then, based on a corresponding authentication logic, authenticate the electronic apparatus according to authentication data based on the encryption logic. Whereby, mobile apparatuses with different operating types are applicable to the authentication apparatus according to the invention, and user convenience is rendered contributable to new mobile apparatuses for operating in coordination with the authentication apparatus need not be additionally provided.

### BRIEF DESCRIPTION OF THE DRAWINGS

The present invention will become more readily apparent to those ordinarily skilled in the art after reviewing the following detailed description and accompanying drawings, in which:

FIG. 1 is a functional block diagram of an authentication apparatus according to one embodiment of the invention.

FIG. 2 is a functional block diagram of an authentication system according to another embodiment of the invention.

FIG. 3 is a flowchart of an authentication method according to another embodiment of the invention.

### DETAILED DESCRIPTION OF THE PREFERRED EMBODIMENT

In an authentication apparatus, system and method disclosed by the present invention, based on a communication protocol, an encryption logic is transmitted to an electronic apparatus. Based on a corresponding authentication logic, the electronic apparatus is authenticated according to authentication data based on the encryption logic transmitted from the electronic apparatus. Exemplary embodiments shall be given below for describing characteristics, spirits and advantages as well as implementation convenience of the invention.

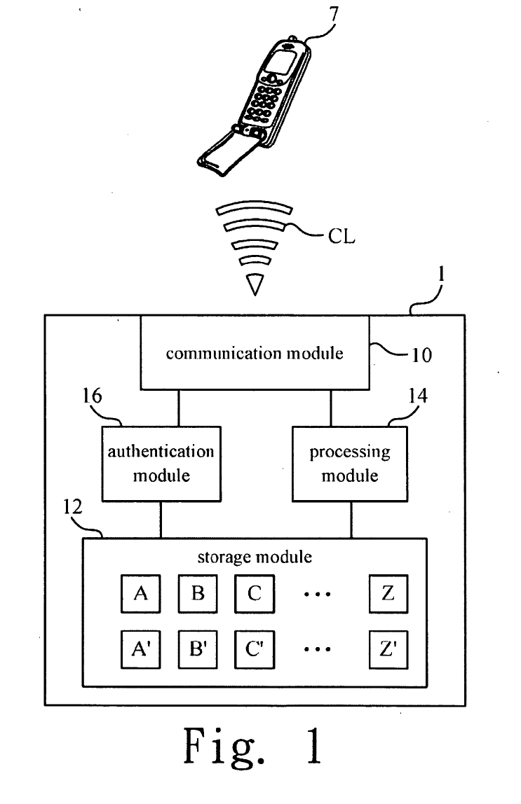

FIG. 1 is a functional block diagram of an authentication apparatus 1 according to one embodiment of the invention. In this embodiment, the authentication apparatus 1 may be applied but not limited to a door control system. For example, the authentication apparatus 1 may be applied to various security mechanisms including electronic keys, member management, petty cash payments and hotel club membership cards.

Referring to FIG. 1, the authentication apparatus 1 comprises a communication module 10, a storage module 12, a processing module 14 and an authentication module 16. The processing module 14 is coupled to the communication module 10 and the storage module 12. The authentication module 16 is similarly coupled to the communication module 10 and the storage module 12.

In this embodiment, the communication module 10 may establish a communication link CL with an electronic apparatus 7 based on a wireless communication protocol. In actual practice, the wireless communication protocol may be but not limited to a Near Field Communication (NFC) protocol. To those skilled in the related art of the invention, NFC techniques are easily accomplished and shall not be unnecessarily further described.

In this embodiment, the storage module 12 stores a plurality of encryption logics A-Z, and a plurality of authentication logics A′-Z′ corresponding to the plurality of encryption logics A-Z. For instance, the encryption logic A is corresponding to the authentication logic A′, the encryption logic B is corresponding to the authentication logic B′, the encryption logic C is corresponding to the authentication logic C′, and so on.

In this embodiment, the processing module 14 chooses a first encryption logic among the plurality of encryption logics A-Z, and transmits the first encryption logic to the electronic apparatus 7 via the communication link CL. In actual practice, based on a predetermined condition, the processing module 14 may choose the first encryption logic and transmit the first encryption logic to the electronic apparatus 7 via the communication link CL. Wherein, the predetermined condition may include but not limited to descriptive information on an operating platform of the electronic apparatus 7.

For example, the encryption logic A may be application software executed on a Symbian operating system, and the encryption logic B may be application software executed on a Windows CE operating system. At this point, suppose the descriptive information on the operating system of the electronic apparatus 7 indicates that the operating system of the electronic apparatus 7 is a Symbian operating system, the processing module 14 may choose the encryption logic A as the first encryption logic, which is then transmitted to the electronic apparatus 7 via the communication link CL. Accordingly, the electronic apparatus 7 has an advantage of being adaptive to various operating platforms to operate in coordination with different electronic apparatuses. It is to be noted that, the predetermined condition is not limited to descriptive information on operating platforms, but may be any other predetermined condition such as algorithm capability.

In this embodiment, based on the first encryption logic, the authentication module 16 receives the authentication data from the electronic apparatus 7 via the communication link CL. A first authentication logic corresponding to the first encryption logic is retrieved from the storage module 12, and the electronic apparatus 7 is authenticated according to the authentication data based on the first authentication logic. In one embodiment, the electronic apparatus 7 may generate the authentication data by executing the first encryption logic.

In actual practice, both of each of the plurality of encryption logics A-Z and the corresponding authentication logic comply with a same cryptographic protocol. For example, the cryptographic protocol of the encryption logic A adds up numbers of all digits in a prompting code transmitted from the authentication apparatus 1 to generate identification data. To be more explicit, suppose the prompting code is 1234567, the electronic apparatus 7 generates the identification data based on the encryption logic A; that is, 1+2+3+4+5+6+7=28. The authentication logic A′ corresponding to the encryption logic A, according to the same cryptographic protocol, compares a sum of the numbers of all digits in the prompting code with the identification data, and determines whether the electronic apparatus 7 passes authentication according to the comparison result.

It is to be noted that, the cryptographic protocol may be a complex encryption/decryption algorithm or a simple identification authentication, depending on requirements of actual practice. For example, in the event that the electronic apparatus 7 has a powerful algorithm capability, and a user of the authentication apparatus 1 pays much attention to security control, the cryptographic protocol may adopt a complex encryption/decryption method in order to increase security. In the event that the electronic apparatus 7 is not provided with digital algorithm capability but only simply offers authentication codes, the cryptographic protocol may also be an uncomplicated authentication code comparison. It is observed from the above description that, the authentication apparatus 1 provides different encryption logics and corresponding authentication logics for operating in coordination with various electronic apparatuses 7, thereby providing usage flexibility as well as convenience.

In actual practice, the electronic apparatus 7 may comprise a first identification code. The processing module 14 may read the first identification code of the electronic apparatus 7, and establish a link between the first authentication logic and the first identification code. Accordingly, the authentication module 16 may use the link to retrieve the first authentication logic corresponding to the first encryption logic from the storage module 12 according to the first identification code, and authenticate the electronic apparatus 7 according to the authentication data based on the first authentication logic.

In actual practice, the authentication apparatus 1 may comprise a second identification code. The electronic apparatus 7 may read the second identification code, and establish a link between the second identification code and the first encryption logic. The electronic apparatus 7 may then choose the first encryption logic according to the second identification code, and generate the authentication data by executing the first encryption logic.

In actual practice, the electronic apparatus 7 may be further stored with a second encryption logic, which is independent of the plurality of encryption logics A-Z. In other words, the second encryption logic is not received from the authentication apparatus 1 but is received from other authentication apparatuses. The electronic apparatus 7 may then generate the authentication data by randomly executing the first encryption logic or the second encryption logic. In practice, suppose the authentication data is generated based on the second encryption logic, the electronic apparatus 7 shall not be approved when the authentication module 16 authenticates the electronic apparatus 7 according to the authentication data. At this point, the authentication module 16 may continue to receive other authentication data generated based on the first encryption logic from the electronic apparatus 7, which shall then pass the authentication when the authentication module 16 authenticates the electronic apparatus 7 according to the authentication data.

To take the authentication apparatus 1 applied to a security mechanism of a door control system for example, the security mechanism may be divided into an encryption logic establishment phase and an authentication determination phase. During the preceding encryption logic establishment phase, a user registers the electronic apparatus 7 to be used to the authentication apparatus 1, so as to facilitate the electronic apparatus 7 to pass authentication by the authentication apparatus 1 when later the user wishes to use the electronic apparatus 7. At this point, the user may locate the electronic apparatus 7 at a certain distance from the authentication apparatus 1, such that a communication link CL based on NFC is established between the communication module 10 of the authentication apparatus 1 and the electronic apparatus 7.

According to the operating system of the electronic apparatus 7, the operating system being a Symbian operating system in this exemplary embodiment, the processing module 14 chooses the encryption logic A as the first encryption logic among the plurality of encryption logics A-Z. The first encryption logic, as the encryption logic A executable by the Symbian operating system, is transmitted to the electronic apparatus 7 via the communication link CL. Meanwhile, the processing module 14 reads a first identification code of the electronic apparatus 7, and establishes a link between the first identification code and the first authentication logic, which is the authentication logic A′ corresponding to the encryption logic A. Further, the electronic apparatus 7 may also read a second identification code of the authentication apparatus 1, and establish a link between the second identification code and the first encryption logic. The encryption logic establishment phase is completed at this point.

During the authentication determination phase, the user uses the electronic apparatus 7 to pass the security mechanism of the door control system. Similarly, the user may locate the electronic apparatus 7 at a certain distance from the authentication apparatus 1, such that a communication link CL based on NFC is established between the communication module 10 of the authentication apparatus 1 and the electronic apparatus 7.

Next, the electronic apparatus 7 reads the second identification code of the authentication apparatus 1, chooses the first encryption code according to the second identification code, and generates the authentication data by executing the first encryption logic. The authentication module 16 receives the authentication data and the first identification code from the electronic apparatus 7 via the communication link CL, retrieves the first authentication logic from the storage module 12 according to the first identification code, and authenticates the electronic apparatus 7 according to the authentication data based on the first authentication logic. Suppose the authentication is successful, the user is allowed to pass the security mechanism of the door control system.

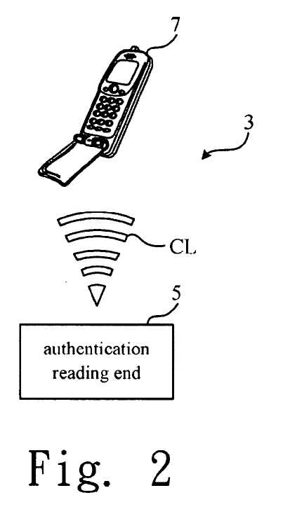

FIG. 2 shows a functional block diagram of an authentication system 3 realizing a security mechanism according to another embodiment of the invention. In actual practice, the authentication system 3 may be applied but not limited to a door control system. Referring to FIG. 2, the authentication system 3 comprises the electronic apparatus 7 and an authentication reading end 5. In this embodiment, the electronic apparatus 7 has an operating type that may include an operating platform of the electronic apparatus 7, and the authentication reading end 5 may be similar to the authentication apparatus 1 in FIG. 1. Exemplary embodiment and applications of the authentication apparatus 1 are as discussed above, and shall not be unnecessarily further described.

In this embodiment, the authentication reading end 5, stored with a plurality of encryption logics A-Z, chooses a target encryption logic among the plurality of encryption logics A-Z according to the operating type, and transmits the target encryption logic to the electronic apparatus 7 via the communication link CL. In actual practice, the electronic apparatus 7 and the authentication reading end 5 have NFC capabilities. To be more exact, the communication link CL may be established based on an NFC protocol.

In this embodiment, the electronic apparatus 7 generates authentication data by executing the target encryption logic, and transmits the authentication data to the authentication reading end 5. The authentication reading end 5 determines whether the electronic apparatus 7 is approved by a security mechanism according to the authentication data.

In actual practice, the electronic apparatus 7 may comprise a first identification code. The authentication reading end 5 may read the first identification code, establish a link between the first identification code and the target encryption logic, retrieve a corresponding authentication logic according to the first identification code, and determine whether the authentication data is approved by the authentication logic. Further, the authentication reading end 5 may comprise a second identification code. The electronic apparatus 7 may read the second identification code, establish a link between the second identification code and the target encryption logic, and chooses the target encryption logic according to the second identification code.

In actual practice, the electronic apparatus 7 may be further stored with a first encryption logic, and randomly execute the target encryption logic or the first encryption logic. Wherein, the first encryption logic is independent of the plurality of encryption logics.

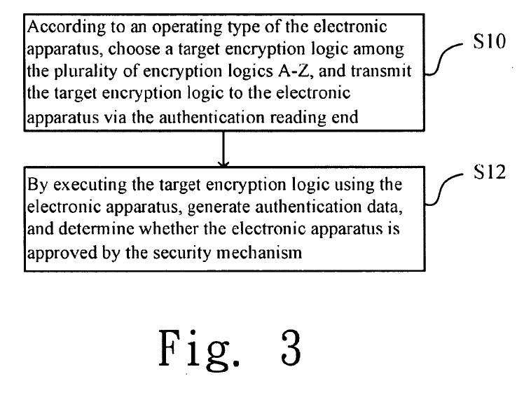

Refer to FIG. 3 showing a flowchart of an authentication method according to another embodiment of the invention with reference to FIG. 1 and FIG. 2. In this embodiment, the authentication method is used for determining whether the electronic apparatus 7 is approved by a predetermined security mechanism at the authentication reading end 5. In actual practice, the authentication method may be applied but not limited to a door control system.

In actual practice, the authentication method may be applied to the authentication apparatus 1 shown in FIG. 1 or the authentication system 3 shown in FIG. 2. Structures and correlations of the authentication apparatus 1 and the authentication system 3 are as discussed above, and shall not be unnecessarily further described.

As shown in FIG. 3, the authentication method starts with an encryption logic establishment step S10. According to an operating type of the electronic apparatus 7, choose a target encryption logic among the plurality of encryption logics A-Z, and transmit the target encryption logic to the electronic apparatus 7 via the authentication reading end 5. In actual practice, the encryption logic establishment step S10 may comprise a step of detecting the operating type of the electronic apparatus 7 using the authentication reading end 5. The operating type may include but not limited to an operating system of the electronic apparatus 7.

Subsequently, the authentication method performs an authentication determination step S12. By executing the target encryption logic using the electronic apparatus 7, generate authentication data, and determine whether the electronic apparatus 7 is approved by the security mechanism.

In actual practice, the electronic apparatus may include a first identification code. The encryption logic establishment step S10 may further comprise steps of reading the first identification code, and establishing a link between the first identification code and the target authentication logic. Wherein, the target authentication corresponds to the target encryption logic. The authentication determination step S12 may further comprise steps of retrieving the target authentication logic according to the first identification code, and determining whether the authentication data is approved by the target authentication logic.

In actual practice, the authentication reading end 5 may include a second identification code. The encryption logic establishment step S10 may further comprise steps of transmitting the second identification code to the electronic apparatus 7, and establishing a link between the second identification code and the target encryption logic. The authentication determination step S12 may further comprise a step of retrieving the target encryption logic according to the second identification code.

Using an authentication apparatus, system and method according to the invention, based on a wireless communication protocol, an encryption logic is transmitted to an electronic apparatus. Based on a corresponding authentication logic, the electronic apparatus is authenticated according to authentication data based on the encryption logic transmitted from the electronic apparatus. Thus, sophistication of a security mechanism is increased to prevent those with bad intentions from easily acquiring authentication codes through particular means to cause user losses. Further, the authentication apparatus is compatible with different operating platforms, such that different encryption logics and corresponding authentication logics may be designated according to types of electronic apparatuses. To be more precise, the authentication apparatus is capable of authenticating all kinds of electronic apparatuses. Therefore, user convenience is rendered contributable to new authentication objects or electronic devices for operating in coordination with the authentication apparatus need not be additionally provided.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An authentication apparatus, comprising:
a communication module, for establishing a communication link with an electronic apparatus based on a wireless communication protocol;
a storage module, for storing a plurality of encryption logics and a plurality of authentication logics corresponding to the plurality of encryption logics;
a processing module, coupled to the communication module and the storage module, for choosing a first encryption logic among the plurality of encryption logics and transmitting the first encryption logic to the electronic apparatus via the communication link; and
an authentication module, coupled to the communication module and the storage module, for receiving authentication data based on the first encryption logic from the electronic apparatus via the communication link, retrieving a first authentication logic corresponding to the first encryption logic from the storage module, and authenticating the electronic apparatus according to the authentication data based on the first authentication logic.

2. The authentication apparatus as claimed in claim 1, wherein the wireless communication protocol is a Near Field Communication (NFC) protocol.

3. The authentication apparatus as claimed in claim 1, wherein when the communication link is established by the communication module, the processing module chooses the first encryption logic based on a predetermined condition and transmits the first encryption logic to the electronic apparatus via the communication link.

4. The authentication apparatus as claimed in claim 3, wherein the predetermined condition comprises descriptive information on an operating platform of the electronic apparatus.

5. The authentication apparatus as claimed in claim 1, wherein the electronic apparatus comprises an identification code, and the processing module reads the identification code of the electronic apparatus and establishes a link between the first authentication logic and the identification code.

6. An authentication method for determining whether an electronic apparatus is approved by an authentication reading end, comprising:
an encryption logic establishment step of choosing a target encryption logic among a plurality of encryption logics according to an operating type of the electronic apparatus, and transmitting the target encryption logic to the electronic apparatus via the authentication reading end; and
an authentication determination step of generating authentication data by executing the target encryption logic by the electronic apparatus, and determining whether the electronic apparatus is approved according to the authentication data.

7. The authentication method as claimed in claim 6, wherein the encryption logic establishment step further comprises detecting the operating type of the electronic apparatus by the authentication reading end.

8. The authentication method as claimed in claim 6, wherein the operating type comprises an operating platform of the electronic apparatus.

9. The authentication method as claimed in claim 6, wherein:
the electronic apparatus comprises a first identification code;
the encryption logic establishment step further comprises reading the first identification code, and establish a link between the first identification code and a target authentication logic, which is corresponding to the target encryption logic; and
the authentication determination step further comprises retrieving the target authentication logic according to the first identification code, and determining whether the authentication data satisfies the target authentication logic.

10. The authentication method as claimed in claim 6, wherein:
the authentication reading end comprises a second identification code;
the encryption logic establishment step further comprises transmitting the second identification code to the electronic apparatus, and establishing a link between the second identification code and the target encryption logic; and
the authentication determination step further comprises choosing the target encryption logic according to the second identification code.

11. The authentication method as claimed in claim 6, wherein the electronic apparatus and the authentication reading end have Near Field Communication (NFC) capabilities.

12. The authentication method as claimed in claim 6, wherein the electronic apparatus further stores a first encryption logic, and the electronic apparatus randomly executes the target encryption logic or the first encryption logic in the authentication determination step.

13. The authentication method as claimed in claim 12, wherein the first encryption logic is independent of the plurality of encryption logics.

14. An authentication system, comprising:
an electronic apparatus with an operating type; and
an authentication reading end, for storing a plurality of encryption logics, choosing a target encryption logic among the plurality of encryption logics according to the operating type, and transmitting the target encryption logic to the electronic apparatus via a communication protocol;
wherein, the electronic apparatus generates authentication data by executing the target encryption logic and transmits the authentication data to the authentication reading end, and the authentication reading end determines whether the electronic apparatus is approved according to the authentication data.

15. The authentication system as claimed in claim 14, wherein the operating type comprises an operating platform of the electronic apparatus.

16. The authentication system as claimed in claim 14, wherein the electronic apparatus and the authentication reading end have Near Field Communication (NFC) capabilities.

17. The authentication system as claimed in claim 14, wherein the electronic apparatus further stores a first encryption logic, and the electronic apparatus randomly executes the target encryption logic or the first encryption logic.

18. The authentication system as claimed in claim 17, wherein the first encryption logic is independent of the plurality of encryption logics.

19. The authentication system as claimed in claim 14, wherein:
the electronic apparatus comprises a first identification code; and
the authentication reading end reads the first identification code, establishes a link between the first identification code and the target encryption logic, retrieves a corresponding authentication logic according to the first identification code, and determines whether the authentication data satisfies the authentication logic.

20. The authentication system as claimed in claim 14, wherein:
the authentication reading end comprises a second identification code; and
the electronic apparatus reads the second identification code, establishes a link between the second identification code and the target encryption logic, and chooses the target encryption logic according to the second identification code.
